(19) United States
(12) Patent Application Publication
(10) Pub. No.: US 2016/0327747 A1
(43) Pub. Date: Nov. 10, 2016

(54) PRINTED BALL LENS AND METHODS FOR THEIR FABRICATION

(71) Applicant: EMPIRE TECHNOLOGY DEVELOPMENT LLC, Wilmington, DE (US)

(72) Inventor: Vincenzo CASASANTA, III, Woodinville, WA (US)

(73) Assignee: EMPIRE TECHNOLOGY DEVELOPMENT LLC, Wilmington, DE (US)

(21) Appl. No.: 15/035,445

(22) PCT Filed: Nov. 8, 2013
(86) PCT No.: PCT/US13/69272

§ 371 Date: May 9, 2016

(51) Int. Cl. G02B 6/30; G02B 6/32; B29D 11/00; G02B 7/02

(52) U.S. Cl. CPC G02B 6/30; G02B 7/027; G02B 6/32; B29D 11/00692; B29D 11/00365; B29K 2105/0061

(57) ABSTRACT

Optical elements, particularly micro-ball lenses, and methods of forming optical elements are described. A method of forming micro-ball lenses may include providing a textured substrate, depositing one or more droplets of ball lens precursor material on the surface of the textured substrate, and curing the one or more droplets of ball lens precursor material. A surface of the textured substrate may include a plurality of protrusions. Each droplet may be configured to form a substantially spherical shape on the surface of the textured substrate without dispersing within one or more cavities located between the protrusions.

### BACKGROUND

Planar waveguide structures include a substrate with an array of patterned waveguides in the interior and a coupling device at the periphery. The coupling device allows for a connection to external fibers that carry incoming and/or outgoing data. The physical connection between the external fibers and the planar waveguides can be achieved with a ball lens.

Previous attempts to fabricate micro-ball lenses involved etching a pyramidal trench in a silicon substrate using potassium hydroxide and placing a glass ball lens at the periphery of a silicon die during formation of a silicon optical microelectromechanical system (MEMS) such that the micro-ball lens is precisely aligned with fibers situated in etched v-grooves in the silicon substrate.

One drawback to this fabrication method is that the micro-ball lens must be placed precisely to ensure proper optical propagation through the waveguide. This is because the micro-ball lens cannot be formed as a sphere using droplet formation methods. Forming a micro-ball lens via droplets causes the shape of the lens to be determined by the surface tension of the substrate. For surface energies that give contact angles with respect to the substrate below 90°, the droplet method produces long f number planoconvex lenses up to a hemispherical shape. The maximum contact angle that can be produced on a substrate with maximum hydrophobicity (lowest surface energy) has been found to be 120°. Therefore, formation of a fully spherical ball lens via the droplet method has not been possible.

### SUMMARY

In an embodiment, a method of fabricating an optical element may include providing a textured substrate, depositing one or more droplets of ball lens precursor material on the surface of the textured substrate, and curing the one or more droplets of ball lens precursor material. A surface of the textured substrate may include a plurality of protrusions. Each precursor droplet may be configured to form a substantially spherical shape on the surface of the textured substrate without dispersing within one or more cavities between the plurality of protrusions.

In an embodiment, an optical element may include one or more ball lenses arranged on a textured substrate having a plurality of protrusions. Each ball lens may be substantially spherical in shape and may have a contact angle on the surface of the textured substrate that is greater than or equal to about 120°.

In an embodiment, an article of manufacture may include an optical element having one or more ball lenses arranged on a textured substrate having a plurality of protrusions. Each ball lens may be substantially spherical in shape and may have a contact angle on the textured substrate that is greater than or equal to about 120°.

### BRIEF DESCRIPTION OF THE DRAWINGS

FIG. 1 depicts a graphical view of a ball lens mounted in a trench according to an embodiment.

FIG. 2 depicts (a) a perspective view of a micro-ball lens that has been formed on a textured substrate, (b) a side view of a micro-ball lens that has been formed on a textured substrate, (c) an expanded view of a contact area between the micro ball lens and the textured substrate, and (d) a top cross-sectional view of the micro-ball lens upon the textured substrate according to an embodiment.

FIG. 3 depicts a flow diagram of a method of forming a textured substrate according to an embodiment.

FIG. 4 depicts a flow diagram of a method of fabricating a ball lens according to an embodiment.

FIG. 5 depicts a graphical diagram of a method of fabricating a ball lens according to an embodiment.

FIG. 6 depicts a chart showing contact angles of a droplet of water with respect to various radii of protrusions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present disclosure relates generally to optical elements that are used to provide a low loss connection between external fibers and planar waveguides. The optical elements described herein may generally be ball lenses having a substantially spherical shape or a spherical shape. A method described herein may allow for creation of a ball lens such that the ball lens has a contact angle with a surface of a substrate on which it is formed of greater than or equal to about 120°. Such methods described herein may avoid the need to fabricate two hemispherical portions that must be placed together, the need to apply droplets of precursor materials at very precise angles, or spinning, moving, angling, or rotating the substrate and/or the precursor applicator to obtain a substantially spherical ball lens or a spherical ball lens.

The optical elements described herein may generally include one or more portions of various microelectronic chips, micro-optical switches, wavelength division multiplexing transmission systems, microelectromechanical systems, and the like. However, those skilled in the art will recognize that the optical elements may also be used for other applications not specifically described herein without departing from the scope of the present disclosure.

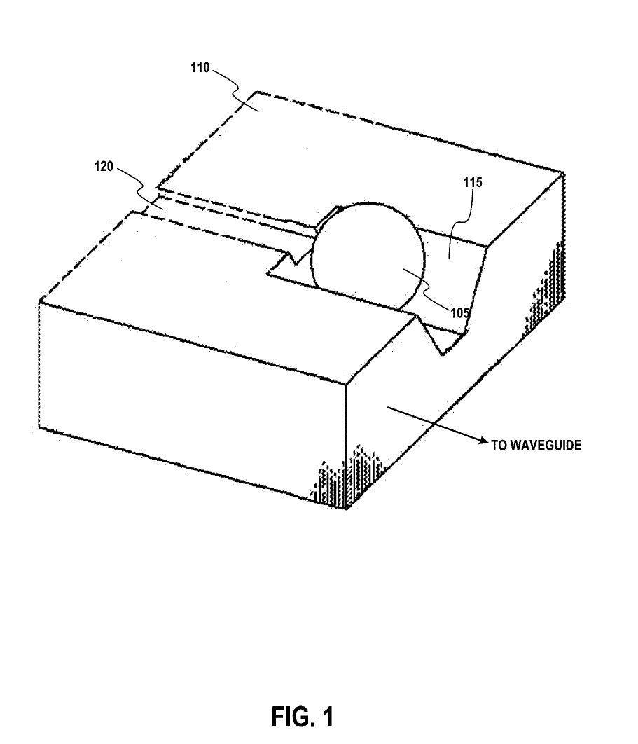

FIG. 1 depicts a graphical view of a ball lens 105 mounted in a trench 115 according to an embodiment. The trench may be formed in a substrate 110, such as, for example a silicon substrate. However, the substrate 110 is not limited by this disclosure and may be any substrate, particularly substrates used for waveguide structures and microelectromechanical systems (MEMS).

In various embodiments, the ball lens 105 may provide a connection to one or more fibers placed in a fiber trench 120 of the substrate 110, such as, for example, one or more external waveguide fibers. The connection may generally be an optical connection such that optical signals that are transmitted via the one or more fibers are propagated through the ball lens 105. The connection between the ball lens 105 and the one or more fibers may have generally any coupling length, such as a coupling length of about 1 micrometer to about 2000 micrometers, including about 1 micrometer, about 5 micrometers, about 10 micrometers, about 25 micrometers, about 50 micrometers, about 100 micrometers, about 150 micrometers, about 200 micrometers, about 250 micrometers, about 500 micrometers, about 600 micrometers, about 750 micrometers, about 800 micrometers, about 900 micrometers, about 1000 micrometers, or any value or range between any two of these values (including endpoints).

In some embodiments, the ball lens 105 may provide a connection to a waveguide, such as, for example, a planar waveguide. The connection may generally be an optical connection such that optical signals that are transmitted to or from the waveguide are propagated through the ball lens 105. The connection between the ball lens 105 and the waveguide may have generally any coupling length, such as a coupling length of about 1 micrometer to about 2000 micrometers, including about 1 micrometer, about 5 micrometers, about 10 micrometers, about 25 micrometers, about 50 micrometers, about 100 micrometers, about 150 micrometers, about 200 micrometers, about 250 micrometers, about 500 micrometers, about 600 micrometers, about 750 micrometers, about 800 micrometers, about 900 micrometers, about 1000 micrometers, about 1250 micrometers, about 1500 micrometers, about 1750 micrometers, about 2000 micrometers, or any value or range between any two of these values (including endpoints).

By providing an optical connection with the fibers and the waveguide, the ball lens 105 may provide a free space optical path between the fibers and the waveguide. Thus, optical signals may be propagated through the ball lens 105 between the fibers and the waveguide. In some embodiments, the optical element may exhibit a maximum coupling efficiency of about 50% to about 100%, including about 50%, about 55%, about 60%, about 65%, about 70%, about 75%, about 80%, about 85%, about 90%, about 95%, about 100%, or any value or range between any two of these values (including endpoints). Coupling efficiency, otherwise known as insertion loss, may be any coupling efficiency standard recognized by those with ordinary skill in the art. An illustrative coupling efficiency standard is the International Specification IEC 61753-1 “Fibre optics interconnecting devices and passive components performance standard.” The coupling efficiency, as used herein, refers to the proportion of an optical power in the one or more fibers that is coupled into the waveguide via the ball lens 105.

In various embodiments, the ball lens 105 may be substantially spherical in shape and may be of any desired size for ball lenses. Illustrative ball lens diameters may include about 5 micrometers to about 1000 micrometers, including about 5 micrometers, about 10 micrometers, about 25 micrometers, about 40 micrometers, about 50 micrometers, about 75 micrometers, about 100 micrometers, about 250 micrometers, about 300 micrometers, about 400 micrometers, about 500 micrometers, about 750 micrometers, about 1000 micrometers, or any value or range between any two of these values (including endpoints). In some embodiments, the ball lens may have a size that is sufficient for the desired function of the ball lens. For example, the ball lens may be sufficiently shaped for a desired focal length, a numerical aperture of the connecting fiber, a wavelength of the light, and/or the like.

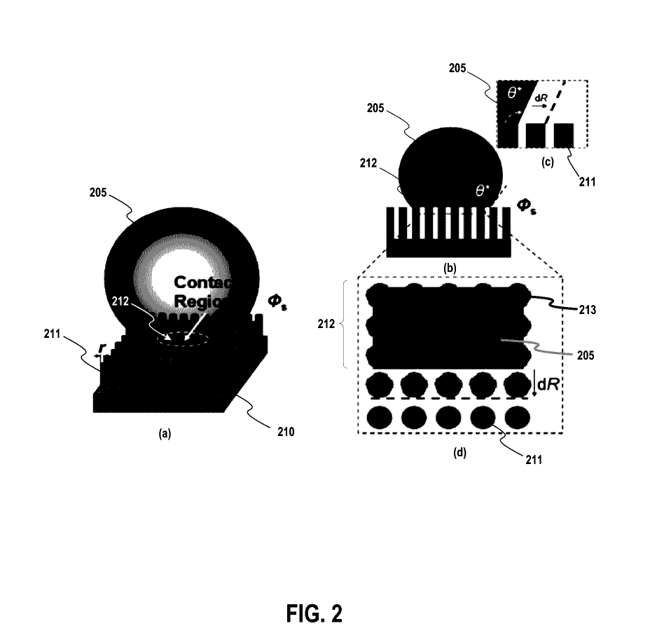

FIG. 2 depicts (a) a perspective view of a micro-ball lens 205 that has been formed on a textured substrate 210, (b) a side view of a micro-ball lens that has been formed on a textured substrate, (c) an expanded view of a contact area between the micro ball lens and the textured substrate, and (d) a top cross-sectional view of the micro-ball lens upon the textured substrate according to an embodiment.

In various embodiments, the textured substrate 210 may be made of any material suitable for forming and/or supporting a precursor material as described herein. Illustrative examples of materials that may be used for the substrate include silicon, quartz, diamond, GaAs, ZnS, Ge, SiGe, GaInP, InP, AlGaAs, GaInAs, AlInGaP, GaAsN, GaN, GaInN, InN, GaInAlN, GaAlSb, GaInAlSb, CdTe, MgSe, MgS, 6HSiC, ZnTe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, AlSb, or a combination thereof.

In various embodiments, the textured surface 212 may include a plurality of protrusions 211. The protrusions are not limited by this disclosure, and may generally be of any shape and/or size. An illustrative protrusion, such as the protrusions 211 shown in FIG. 2, may be cylindrical shaped. Other protrusion shapes may include protrusions having a horizontal cross section that is circular, round, elliptical, semicircular, truncated circular, square shaped, rectangular shaped, trapezoidal shaped, triangle shaped, star shaped, or the like. In some embodiments, the size of each protrusion 211 may be defined by a width, such as, for example, a radius. Illustrative widths for each protrusion 211 may include about 1 nanometer to about 10 micrometers, including about 1 nanometer, about 20 nanometers, about 50 nanometers, about 100 nanometers, about 500 nanometers, about 1 micrometer, about 3 micrometers, about 4 micrometers, about 5 micrometers, about 6 micrometers, about 7 micrometers, about 8 micrometers, about 9 micrometers, about 10 micrometers, or any value or range between any two of these values (including endpoints). In some embodiments, each protrusion 211 may have a height. The height may be the same for all protrusions, or may vary for one or more protrusions. Illustrative heights may include about 0.1 micrometers to about 10 micrometers, including about 0.1 micrometers, about 0.5 micrometers, about 1 micrometer, about 2 micrometers, about 3 micrometers, about 4 micrometers, about 5 micrometers, about 6 micrometers, about 7 micrometers, about 8 micrometers, about 9 micrometers, about 10 micrometers, or any value or range between any two of these values (including endpoints). Each of the protrusions 211 may have a contact surface that corresponds to a surface that may come into contact with at least a portion of the micro-ball lens 205.

In various embodiments, the protrusions 211 may be arranged in any manner. For example, the protrusions 211 may be arranged in a grid-like formation, in a random arrangement, or in a periodic arrangement. In some embodiments, the protrusions 211 may be spaced at a distance from each other. For example, each protrusion 211 may be spaced at a distance of about 1 nanometer to about 10 micrometers from every protrusion adjacent to it, including about 1 nanometer, about 20 nanometers, about 50 nanometers, about 100 nanometers, about 500 nanometers, about 1 micrometer, about 3 micrometers, about 4 micrometers, about 5 micrometers, about 6 micrometers, about 7 micrometers, about 8 micrometers, about 9 micrometers, about 10 micrometers, or any value or range between any two of these values (including endpoints). The distance measured for the spacing may be from a central point of each protrusion 211 or may be from an edge of each protrusion. In some embodiments, the protrusions may have a density or a solid area coverage over the surface of the textured substrate. Illustrative solid area coverage may be about 20% to about 80% of the total surface area of the surface of the textured substrate, including about 20%, about 25%, about 30%, about 35%, about 40%, about 45%, about 50%, about 55%, about 60%, about 65%, about 70%, about 75%, about 80%, or any value or range between any two of these values (including endpoints).

In various embodiments, the protrusions 211 may allow the textured substrate 210 to exhibit super-hydrophobicity. In some embodiments, the protrusions may allow the textured substrate 210 to exhibit ultra-hydrophobicity. Thus, the textured substrate 210 described herein may be either a super-hydrophobic substrate or an ultra-hydrophobic substrate. A super-hydrophobic substrate, as described herein, may be a substrate that forms a contact angle with a water droplet of about 150° or greater. An ultra-hydrophobic substrate, as described herein, may be a substrate that forms a contact angle with a water droplet of about 120° or greater.

The micro-ball lens 205, when deposited on the textured substrate 210 (as described in greater detail herein), may form a contact region 212. The contact region 212 may generally correspond to an area of the micro-ball lens 205 that is proximate to at least a portion of the textured substrate 210. Because the textured substrate 210 may contain a plurality of protrusions 211 as described herein, some portions of the contact region 212 may not be in contact with the substrate.

Natural surfaces of animals and plants exhibit super hydrophobicity that exceeds hydrophobicity observed on fully fluorinated surfaces. Studies have shown that this hydrophobicity property is due to nano-texturing of the surface. The hydrophobicity of the surface can be expressed by the Cassie-Baxter equation, but more accurately with Equation (1):

$$cos {θ}^{*} = - 1 + ( cos θ + 1 ) - \frac{2 {Φ}_{s} τ}{r {γ}_{LV}} \qquad ( 1 )$$

where θ* is the contact angle on a textured surface for a given material set, θ is the contact angle on a smooth surface for the same material set, Φₛ is the fraction of the textured surface that is solid (as opposed to free volume), σ is the excess free energy of a three phase system per unit length of a solid-liquid-vapor contact line, γ_{LV} is the surface tension between the liquid phase and the vapor phase, and r is the radius of a protrusion. As previously described herein, the contact angle refers to the liquid side tangential line drawn through the three phase boundary where a liquid, gas, and solid interact.

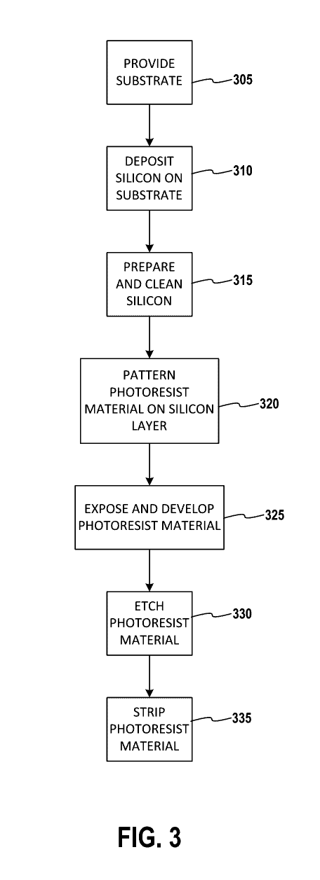

Such a textured surface concept can be applied to artificial surfaces as described herein. FIG. 3 depicts a flow diagram of a method of forming a textured substrate for micro-ball lens formation according to an embodiment. In various embodiments, a substrate may be provided 305. The substrate may be any substrate, and is not limited by this disclosure. In some embodiments, the substrate may be a hydrophobic substrate. In some embodiments, the substrate may be a superhydrophobic substrate. In some embodiments, the substrate may be a rigid substrate. In other embodiments, the substrate may be a flexible substrate. The substrate can be made of any material, and is not limited by this disclosure. Illustrative examples of materials may include, but are not limited to, polyimide, polyethylene naphthalate, polyethylene terephthalate, polyethersulfone, polyetherimide, and any combination thereof. Each dimension of the substrate may be any size that is suitable to support formation at least one micro-ball lens, as described in greater detail herein. For example, the substrate may range from a small sheet that can be used to prepare a small number of micro-ball lenses to a large sheet for a mass production of a large number of micro-ball lenses. Illustrative substrates may have a surface area (length×width) of about 10 square micrometers to about 1 square meter, including about 10 square micrometers, about 50 square micrometers, about 100 square micrometers, about 500 square micrometers, about 1000 square micrometers, about 5 square millimeters, about 10 square millimeters, about 50 square millimeters, about 100 square millimeters, about 500 square millimeters, about 1 square meter, or any value or range between any two of these values (including endpoints). In addition, the substrate may have any thickness, including, for example, a thickness of about 5 micrometers to about 100 micrometers, including about 5 micrometers, about 10 micrometers, about 25 micrometers, about 50 micrometers, about 75 micrometers, about 100 micrometers, or any value or range between any two of these values (including endpoints).

In various embodiments, a layer of silicon may be deposited 310 on the substrate. The silicon may be deposited 310 by any method of deposition, including, for example, via a sputtering method, a chemical vapor deposition method, a high frequency plasma-enhanced chemical vapor deposition, a microwave plasma-enhanced chemical vapor deposition, a plasma-enhanced chemical vapor deposition, and an in-line process that uses ultrasonic nozzles. In some embodiments, the silicon may be amorphous silicon. The silicon may be deposited 310 at any suitable thickness, including, for example, a thickness of about 500 nanometers to about 5000 nanometers, including about 500 nanometers, about 750 nanometers, about 1000 nanometers, about 1500 nanometers, about 2000 nanometers, about 2500 nanometers, about 3000 nanometers, about 4000 nanometers, about 5000 nanometers, or any value or range between any two of these values (including endpoints).

In various embodiments, the substrate may be textured. For example, the substrate may be textured with a plurality of protrusions such as cylindrical columns, as described in greater detail herein. The textured pattern may be created on the silicon using, for example, a photolithography technique. For example, the silicon layer on the substrate may be prepared and cleaned 315 according to common photolithographic methods. A photoresist material may be patterned 320 on the silicon layer. Patterning 320 may include, for example, spin coating or slot die coating the photoresist material onto the silicon layer. The type of photoresist material is not limited by this disclosure and may be any type of photoresist material. An illustrative photoresist material may include MegaPosit™ SPR™ 955-CM photoresist available from the Dow Chemical Company (Midland, Mich.).

In various embodiments, the photoresist material may be exposed and developed 325. The photoresist material may be exposed and developed 325 according to any method now known or later developed, such as, for example, exposing the photoresist material to ultraviolet light and an organic developer. Illustrative organic developers may include, for example, a developer containing sodium hydroxide or a developer that is metal-ion free, such as tetramethylammonium hydroxide.

In various embodiments, the photoresist material may be etched 330 to obtain a textured pattern on the substrate. The photoresist material may generally be etched 330 by any etching method now known or later developed. Etching 330 may generally include use of an etchant, such as a liquid or a plasma chemical agent to remove layers of the silicon that are not protected by the photoresist material mask. Illustrative etching 330 processes may include a deep reactive ion etching process, a chemical etching process, a plasma etching process, or a reactive ion etching process.

In various embodiments, the photoresist material may be stripped 335. The photoresist may be stripped 335 via any removal method now known or later developed. For example, the photoresist can be stripped 335 by using a liquid resist stripper or a plasma-containing oxygen. In some embodiments, the patterned substrate may be cleaned after stripping 335, such as cleaning with a hot piranha solution. The hot piranha solution may be a mixture suitable for cleaning organic residue off the substrate. In some embodiments, the hot piranha solution may be a mixture of sulfuric acid and hydrogen peroxide.

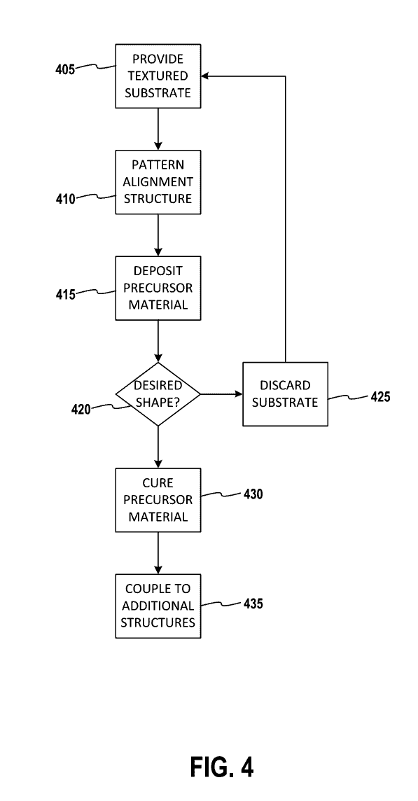

FIG. 4 depicts a flow diagram of a method of forming a micro-ball lens according to an embodiment. In various embodiments, a textured substrate may be provided 405. The textured substrate may generally be provided 405 via the formation method described herein with respect to FIG. 3.

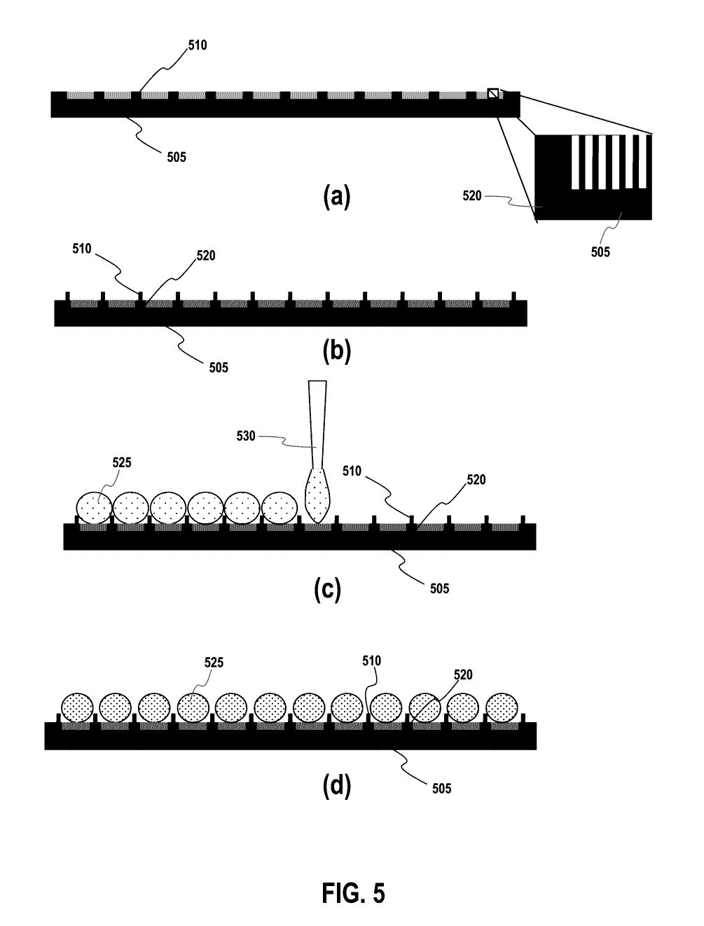

In various embodiments, an alignment structure may be patterned 410 on the textured substrate. The alignment structure is not limited by this disclosure and may generally be any structure that is configured to align the droplets of precursor material on the substrate such that they are properly formed, to center the droplets of precursor material on the substrate, to support the droplets of precursor material on the substrate, and/or to prevent droplets of precursor material from contacting each other. An illustrative alignment structure 510 is depicted in FIG. 5(b). Such an alignment structure 510 may extend from periodic separation posts 520 that extend from the substrate 505. Such periodic separation posts 520 may be made of the same material as the substrate 505 and may extend to a distance that is greater than or equal to the height of the protrusions. Other illustrative alignment structures may include frames, posts, rings, and/or the like. The alignment structure may generally be patterned 410 via any method of patterning now known or later developed, including, for example, any photolithography technique. One specific method of patterning 410 may include applying a negative tone epoxy-based resist to the textured substrate and forming the negative tone epoxy-based resist into a structure around each area on the surface of the textured substrate that is configured to receive a droplet of precursor material. An illustrative example of a negative tone epoxy-based resist may be SU-8 photoresist (MicroChem Corp., Newton, Mass.). Another method of patterning 410 may include forming a trench in the textured substrate. The trench may be of a sufficient size and/or shape that is suitable to receive the precursor material, to ensure the precursor material is formed into a desired shape, and/or to hold the precursor material in a pattern.

Referring back to FIG. 4, in various embodiments, a precursor material may be deposited 415 on the textured substrate. The precursor material may generally be deposited 415 such that a droplet of precursor material is applied to a portion of the substrate between portions of the alignment structure as shown in FIG. 5(c). The precursor material 525 may be deposited 415 by any method of deposition now known or later developed with any deposition apparatus 530. Illustrative deposition methods may include micro-contact printing, deposition via a needle, deposition via a syringe, and deposition via an inkjet printing apparatus. In some embodiments, the precursor material may be deposited 415 such that the precursor droplet forms a contact angle with a surface of the substrate of greater than or equal to about 120°, for example about 120° to about 180°, including about 120°, about 125°, about 130°, about 135°, about 140°, about 145°, about 150°, about 155°, about 160°, about 165°, about 170°, about 175°, about 180°, or any value or range between any two of these values (including endpoints). The precursor droplet may contain about 10 microliters to about 100 microliters of precursor material, including about 10 microliters, about 25 microliters, about 50 microliters, about 75 microliters, about 100 microliters, or any value or range between any two of these values (including endpoints). In some embodiments, the precursor droplet may contain about 16.67 microliters of precursor material.

In various embodiments, the precursor material may generally be a material that is suitable for the formation of a ball lens. Illustrative precursor materials may include optical polymers. Illustrative optical polymers may include one or more of an epoxide, an acrylic, a polyimide, a fluorinated polymer, a silicon containing polymer, or a siloxane. In some embodiments, the precursor material may be a sol-gel material. The sol-gel material may generally be a multiphase system that is nonflowing. The multiphase system can be described as a bicontinuous structure or an interconnected network. One phase of the bicontinuous structure may be described as the scaffolding, and the other phase may be interwoven within the scaffolding. The sol-gel may have a transition temperature that is below a temperature at which the system phases separate to form an interconnected network and above a temperature at which the system phases become miscible and the gel dissolves into a flowing liquid. The transition temperature of the sol-gel may be up to and including about 105° C., including about 0° C., about 10° C., about 25° C., about 40° C., about 50° C., about 75° C., about 100° C., about 105° C., or any value or range between any two of these values (including endpoints).

In various embodiments a determination 420 may be made as to whether the deposited precursor material has a desired shape and/or size. The precursor material may have a desired shape, for example, if it is substantially spherical and/or shaped to achieve the desired function of the resultant micro-ball lens, as described in greater detail herein. The precursor material may have a desired size, for example, if it has a diameter of about 5 micrometers to about 1000 micrometers and/or if it is substantially sized to achieve the desired function of the resultant micro-ball lens, as described in greater detail herein. If the deposited precursor material does not conform to the desired shape and/or size, portions, such as the precursor material and/or the substrate, may be discarded 425 and the process may start over.

If the deposited precursor material does conform to a desired shape and/or size, it may be cured 430. Curing 430 is not limited by this disclosure, and may include any method of curing, particularly those effective to cure materials used to form the micro-ball lens. Illustrative curing methods may include exposing the precursor material to ultraviolet light, thermal curing, photoinitiation, chemical catalyst initiation, and/or the like. Exposure to ultraviolet light may include exposure to a pulsed ultraviolet light. Curing 430 may further include the use of any number of curing agents, including, but not limited to, an epoxide, an alkanol, an aldehyde, a condensation polymer, or any combination thereof.

In some embodiments, curing 430 may cause shrinkage of the deposited precursor material. Thus, the precursor material may be reduced in volume during the curing 430 process. In some embodiments, the volume of the precursor material may be reduced by not more than about 10% by volume of the precursor droplet. Thus, the volume of the precursor material may be reduced to as low as about 90% of its original volume when it is deposited on the textured substrate. In particular embodiments, the precursor material may be reduced by about 0.1%, about 0.25%, about 0.5%, about 1%, about 2%, about 3%, about 4%, about 5%, about 6%, about 7%, about 8%, about 9%, about 10%, or any value or range between any two of these values (including endpoints). In some embodiments, curing 430 may not cause any shrinkage or substantially no shrinkage of the deposited precursor material.

In various embodiments, the cured micro-ball lens may be coupled 435 to other structures. For example, the micro-ball lens may be coupled 435 to an optical fiber and/or a waveguide, as described in greater detail herein. In some embodiments, the micro-ball lens may be coupled to a planar waveguide structure. In some embodiments, the micro-ball lens may be coupled 435 to an external waveguide fiber. Coupling 435 is not limited by this disclosure and may include any physical or optical attachment. In some embodiments, coupling 435 may include removing the cured micro-ball lens from the substrate and placing it on a silicon substrate or the like, as described herein. In some embodiments, coupling 435 may include placing the micro-ball lens in a trench, as described in greater detail herein.

### EXAMPLES

### Example 1

### Forming a Textured Substrate for Micro-Ball Lens Fabrication

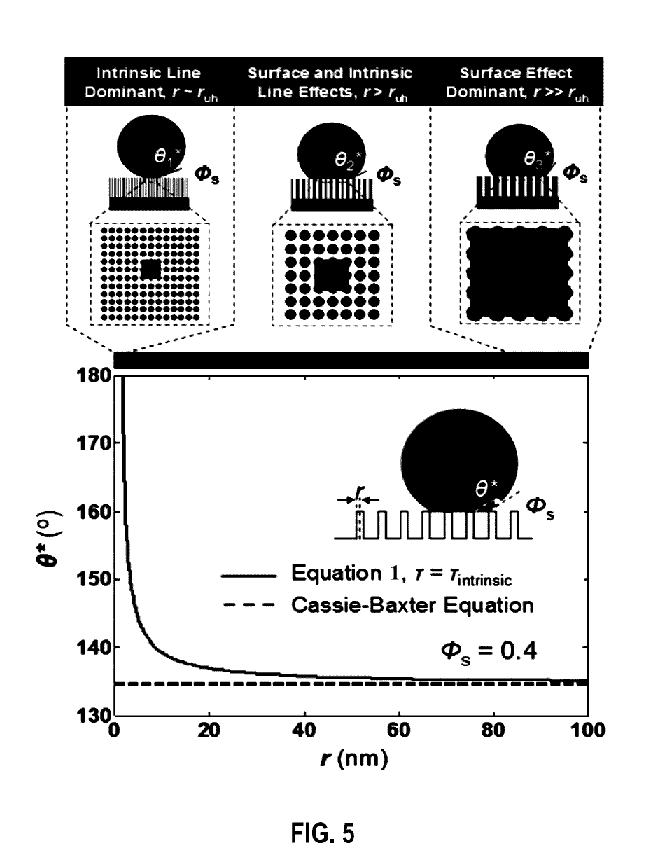

A textured substrate that can be used for the mass production of micro-ball lenses having a diameter of about 1000 micrometers will be formed. A desired substrate is large enough to create millions of micro-ball lenses. Therefore, a substrate with a surface area of about 942 square millimeters will be selected. The substrate will be made of polyimide, be 50 micrometers thick, and will contain a plurality of cylindrical protrusions thereon. The protrusions will have a circular cross sectional shape with a radius of about 20 nanometers. The protrusions will be about 5 micrometers tall. The protrusions will be tightly packed such that the distance from the center of one protrusion to the center of another protrusion is about 40 nanometers. Accordingly, the protrusions will have a solid area coverage of about 50%. Such a size is selected so that the contact angle of the resulting micro-ball lenses will be about 135°-140° according to the graph shown in FIG. 6.

The protrusions will be formed on the substrate by depositing a layer of silicon on the substrate via sputtering. The thickness of the silicon will be about 5 micrometers to ensure that the resultant protrusions are about 5 micrometers tall. A photoresist material will be patterned on the coated substrate via spin coating. The photoresist material will be exposed to ultraviolet light and a developer containing sodium hydroxide. A plasma etchant will be used to remove portions of the silicon layers to form the protrusions via a plasma etching process. The photoresist material will then be stripped from the substrate, and the substrate will be cleaned so that it can be used to form micro-ball lenses.

### Example 2

### Forming Micro-Ball Lenses

A grid-like alignment structure made of silicon and formed via photolithography will be placed over the textured substrate from Example 1 to assist in aligning the micro-ball lenses and to ensure proper formation of micro-ball lenses. The grid will have openings that are sufficiently sized so that the micro-ball lens precursor material can be placed in the openings on the textured substrate without coming into contact with the grid at any time.

The precursor material will be placed on the textured substrate via a micro-contact printing process in an amount that is sufficient to create an uncured micro-ball having a diameter of 1100 micrometers. Curing by pulsed UV light after deposition will cause the micro-ball to shrink to about 1000 micrometers in size, a reduction of about 9.9%. The cured micro-ball lenses will be removed from the substrate and quality control checked for size and shape before they are placed in a MEMS controller to propagate optical signals through the controller. As the micro-ball lenses are at least substantially spherical in shape, precise alignment of the micro-ball lenses with waveguides in the MEMS controller can be facilitated, thereby providing proper optical propogation through the waveguides.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of fabricating an optical element, the method comprising:
providing a textured substrate, wherein a surface of the textured substrate comprises a plurality of protrusions;
depositing one or more droplets of ball lens precursor material on the surface of the textured substrate, wherein each droplet is configured to form a substantially spherical shape on the surface of the textured substrate without dispersing within one or more cavities located between the protrusions; and
curing the one or more droplets of ball lens precursor material.

2. The method of claim 1, wherein providing the textured substrate comprises:
patterning a photoresist material on a substrate, wherein the photoresist material is configured to form one or more windows on the substrate;
exposing the substrate to an etching process to create the plurality of protrusions; and
stripping the photoresist material from the substrate to form the textured substrate.

3. The method of claim 2, wherein the etching process comprises a chemical etching process, a plasma etching process, or a reactive ion etching process.

4. The method of claim 1, further comprising patterning an alignment structure on the textured substrate, wherein the alignment structure is configured to center and support the droplet of ball lens precursor material on the textured substrate.

5. The method of claim 4, wherein patterning the alignment structure comprises:
applying a negative tone epoxy-based resist to the textured substrate; and
forming the negative tone epoxy-based resist into a structure around each area on the surface of the textured substrate that is configured to receive the droplet of ball lens precursor material.

6. (canceled)

7. The method of claim 4, wherein patterning the alignment structure comprises forming a trench in the textured substrate, the trench configured to receive the droplet of ball lens precursor material and hold the droplet of ball lens precursor material in a pattern.

8. The method of claim 1, wherein depositing comprises depositing a sol-gel material.

9. The method of claim 1, wherein depositing comprises depositing an optical polymer selected from an epoxide, an acrylic, a polyimide, a fluorinated polymer, a silicon containing polymer, or a siloxane.

10. The method of claim 1, wherein curing the droplet of ball lens precursor material comprises exposing the droplet of ball lens precursor material to an ultraviolet light.

11.-13. (canceled)

14. The method of claim 1, wherein dispensing the droplet of ball lens precursor material comprises dispensing the droplet through one or more of a micro-contact printing process, a needle, a syringe and an inkjet apparatus.

15.-17. (canceled)

18. The method of claim 1, wherein dispensing the droplet of ball lens precursor material comprises dispensing the droplet such that the droplet has a contact angle on the surface of the textured substrate that is greater than or equal to about 120°.

19. The method of claim 1, wherein providing the textured substrate comprises providing an ultra-hydrophobic textured substrate.

20. The method of claim 1, wherein providing the textured substrate comprises providing a textured substrate comprising silicon, quartz, diamond, GaAs, ZnS, Ge, SiGe, GaInP, InP, AlGaAs, GaInAs, AlInGaP, GaAsN, GaN, GaInN, InN, GaInAlN, GaAlSb, GaInAlSb, CdTe, MgSe, MgS, 6HSiC, ZnTe, GaAsSb, GaSb, InAsN, 4H—SiC, a-Sn, BN, BP, BAs, AlN, ZnO, ZnSe, CdSe, CdTe, HgS, HgSe, PbS, PbSe, PbTe, HgTe, HgCdTe, CdS, ZnSe, InSb, AlP, AlAs, AlSb, InAs, AlSb, or a combination thereof.

21.-22. (canceled)

23. The method of claim 1, wherein providing the textured substrate comprises providing a textured substrate wherein each protrusion of the plurality of protrusions has a shape selected from the group consisting of circular, semicircular, truncated circular, square, rectangular, trapezoidal, and triangular.

24. The method of claim 1, wherein providing the textured substrate comprises providing a textured substrate wherein each protrusion of the plurality of protrusions has an average height of about 0.1 micrometers to about 10 micrometers and an average width of about 1 nanometer to about 10 micrometers.

25. The method of claim 1, wherein providing the textured substrate comprises providing a textured substrate wherein the plurality of protrusions has a solid area coverage of about 20% to about 80% of the total surface area of the surface of the textured substrate.

26. The method of claim 1, further comprising coupling the droplet of ball lens precursor material to one or more of a planar waveguide structure and an external waveguide fiber.

27. (canceled)

28. An optical element comprising one or more ball lenses arranged on a textured substrate having a plurality of protrusions, wherein the ball lens is substantially spherical in shape and has a contact angle on the surface of the textured substrate that is greater than or equal to about 120°.

29. The optical element of claim 28, further comprising an alignment structure on the textured substrate, wherein the alignment structure is configured to center and support the ball lens on the textured substrate.

30. The optical element of claim 29, wherein the alignment structure comprises a negative tone epoxy-based resist formed into a structure around each area on the textured substrate that is configured to receive the ball lens.

31. The optical element of claim 30, wherein the alignment structure comprises at least one of a frame, a post, or a ring.

32. (canceled)

33. The optical element of claim 28, wherein the ball lens comprises a sol-gel material.

34. The optical element of claim 28, wherein the ball lens comprises an optical polymer selected from epoxide, an acrylic, a polyimide, a fluorinated polymer, a silicon containing polymer, or a siloxane.

35. The optical element of claim 28, wherein the textured substrate is an ultra-hydrophobic textured substrate.

36. The optical element of claim 28, wherein the textured substrate comprises silicon, quartz, diamond, GaAs, ZnS, Ge, SiGe, GaInP, InP, AlGaAs, GaInAs, AlInGaP, GaAsN, GaN, GaInN, InN, GaInAlN, GaAlSb, GaInAlSb, CdTe, MgSe, MgS, 6HSiC, ZnTe, GaAsSb, GaSb, InAsN, 4H—SiC, a-Sn, BN, BP, BAs, AlN, ZnO, ZnSe, CdSe, CdTe, HgS, HgSe, PbS, Pb Se, PbTe, HgTe, HgCdTe, CdS, ZnSe, InSb, AlP, AlAs, AlSb, InAs, AlSb, or a combination thereof.

37. The optical element of claim 28, wherein the ball lens has a diameter of about 5 micrometers to about 1000 micrometers.

38. The optical element of claim 28, wherein each protrusion of the plurality of protrusions has a cross-sectional shape selected from the group consisting circular, semicircular, truncated circular, square, rectangular, trapezoidal, and triangular.

39. The optical element of claim 28, wherein each protrusion of the plurality of protrusions has an average height of about 0.1 micrometers to about 10 micrometers and an average width of about 0.1 micrometers to about 10 micrometers.

40. The optical element of claim 28, wherein the plurality of protrusions has a solid area coverage of about 20% to about 80% of the total surface area of a surface of the textured substrate.

41. The optical element of claim 28, wherein the ball lens is coupled to at least one external waveguide fiber and at least one planar waveguide and configured to provide direct coupling between the external waveguide fiber and the planar waveguide.

42.-44. (canceled)

45. The optical element of claim 41, wherein the optical element exhibits a maximum coupling efficiency of about 50% to about 100%.

46.-69. (canceled)
